(19) United States
(12) Patent Application Publication
(10) Pub. No.: US 2013/0178998 A1
(43) Pub. Date: Jul. 11, 2013

(54) SYSTEMS AND METHODS FOR CONTROLLING POWER SYSTEMS

(71) Applicants: Kasi Viswanadha Raju Gadiraju, Bangalore (IN); Mallikarjuna Reddy Vallem, Bangalore (IN); Amol Rajaram Kolwalkar, Bangalore (IN); Gurunath Gurrala, Bangalore (IN); Sanjay Verma, Gurgaon (IN)

(72) Inventors: Kasi Viswanadha Raju Gadiraju, Bangalore (IN); Mallikarjuna Reddy Vallem, Bangalore (IN); Amol Rajaram Kolwalkar, Bangalore (IN); Gurunath Gurrala, Bangalore (IN); Sanjay Verma, Gurgaon (IN)

(73) Assignee: GENERAL ELECTRIC COMPANY, SCHENECTADY, NY (US)

(21) Appl. No.: 13/344,250

(22) Filed: Jan. 5, 2012

(51) Int. Cl. G06F 1/28

(52) U.S. Cl. 700/296

(57) ABSTRACT

A power distribution network system is provided. The system includes a plurality of metering devices configured to generate load side data, a plurality of processing subsystems that is in operational communication with at least one of the plurality of metering devices and a central processing subsystem, wherein the plurality of processing subsystems is configured to receive a subset of the load side data from at least one of the plurality of metering devices, receive supervisory controls and supervisory conditions from the central processing subsystem, determine whether one or more of the supervisory conditions are satisfied based upon the received subset of the load side data, and execute one or more of the supervisory controls based upon the determination whether one or more of the supervisory conditions are satisfied, wherein each of the plurality of processing subsystems is located at a load bifurcation point in the power distribution network.

### BACKGROUND

An electrical grid is an interconnected network for delivering electricity from suppliers to consumers. It consists generally of three main components: 1) generating plants that produce electricity; 2) transmission lines that carry electricity from power plants to demand centers; and 3) distribution lines that carry power for delivery of electricity to consumers. Therefore, in the power industry, an electrical grid is a general term used for an electricity network which includes electricity generation, electricity power transmission and electricity distribution.

Generally, the management of the electrical grid includes two way communications between the control center and devices in the electrical grid, such as, data concentrators, signal repeaters, smart meters etc. Power generation, power flow to consumers and other required controls are typically regulated and managed by the control center. Therefore, the control center typically receives data from various devices in the electrical grid, and controls the electrical grid based upon processing of the received data. The devices may be located at remote locations with respect to the central system which leads to delay in communication and processing of the data, and communication of control signals from the control center to the devices. Furthermore, two way communications between each of the devices and control center leads to consumption of high communication bandwidth. Also, the processing capabilities of the control center needs to be greater for processing massive amount of data received from the devices.

### BRIEF DESCRIPTION

Briefly in accordance with one aspect of the technique, a power distribution network system is presented. The power distribution network system includes a plurality of metering devices configured to generate load side data, a plurality of processing subsystems that is in operational communication with at least one of the plurality of metering devices and a central processing subsystem, wherein the plurality of processing subsystems is configured to receive a subset of the load side data from at least one of the plurality of metering devices, receive supervisory controls and supervisory conditions from the central processing subsystem, determine whether one or more of the supervisory conditions are satisfied based upon the received subset of the load side data, and execute one or more of the supervisory controls based upon the determination whether one or more of the supervisory conditions are met, wherein each of the plurality of processing subsystems is located at a load bifurcation point in the power distribution network.

A power distribution network system is provided. The power distribution system includes a plurality of metering devices configured to generate load side data, a plurality of smart devices that are in operational communication with at least one of the plurality of metering devices and a central processing subsystem, wherein the plurality of processing subsystems are configured to receive a subset of the load side data from at least one of the plurality of metering devices, receive supervisory controls and supervisory conditions from the central processing subsystem, determine whether one or more of the supervisory conditions are met based upon the received subset of the load side data, and execute one or more of the supervisory controls based upon the determination whether one or more of the supervisory conditions are satisfied, wherein each of the plurality of smart devices is located on a transformer.

A method including the following steps is disclosed. The method includes receiving a subset of load side data from at least one metering device, receiving supervisory controls and supervisory conditions from a central processing subsystem, determining whether one or more of the supervisory conditions are satisfied based upon the received subset of the load side data, and executing one or more of the supervisory controls based upon the determination whether one or more of the supervisory conditions are satisfied, wherein each of the plurality of processing subsystems is located at a load bifurcation point in the power distribution network.

### DRAWINGS

These and other features and aspects of embodiments of the present invention will become better understood when the following detailed description is read with reference to the accompanying drawings in which like characters represent like parts throughout the drawings, wherein:

FIG. 1 is a diagrammatic illustration of an exemplary power grid system, in accordance with certain aspects of the present systems and techniques;

FIG. 2 is a diagrammatic illustration of components in a power distribution system, in accordance with an embodiment of the present systems and techniques; and

FIG. 3 is an exemplary flow diagram that describes an optimal management and control of a power distribution system, in accordance with an embodiment of the present techniques.

### DETAILED DESCRIPTION

As discussed in detail below, embodiments of the present systems and techniques disclose smart devices that are located at load bifurcation points in a power grid system. In certain embodiments, the smart devices receive load side data from advanced metering devices placed at a plurality of consumers' locations. As used herein, the term “load side data” is used to refer to data related to electrical power supplied to or received by one or more consumers from an electric utility.

Furthermore, the smart devices receive electrical characteristics from a plurality of sensing devices placed at a plurality of locations in the power grid system. In certain embodiments, the smart devices receive the load side data and the electrical characteristics in real-time. Additionally, the smart devices receive supervisory controls, supervisory conditions and/or preliminary data from a control center located in the power grid system. In the presently contemplated configurations, the smart devices execute the received supervisory controls in respective local area grids based upon the satisfaction of the received supervisory conditions. The smart devices determine the satisfaction of the supervisory conditions based upon the received load side data, electrical characteristics and preliminary data.

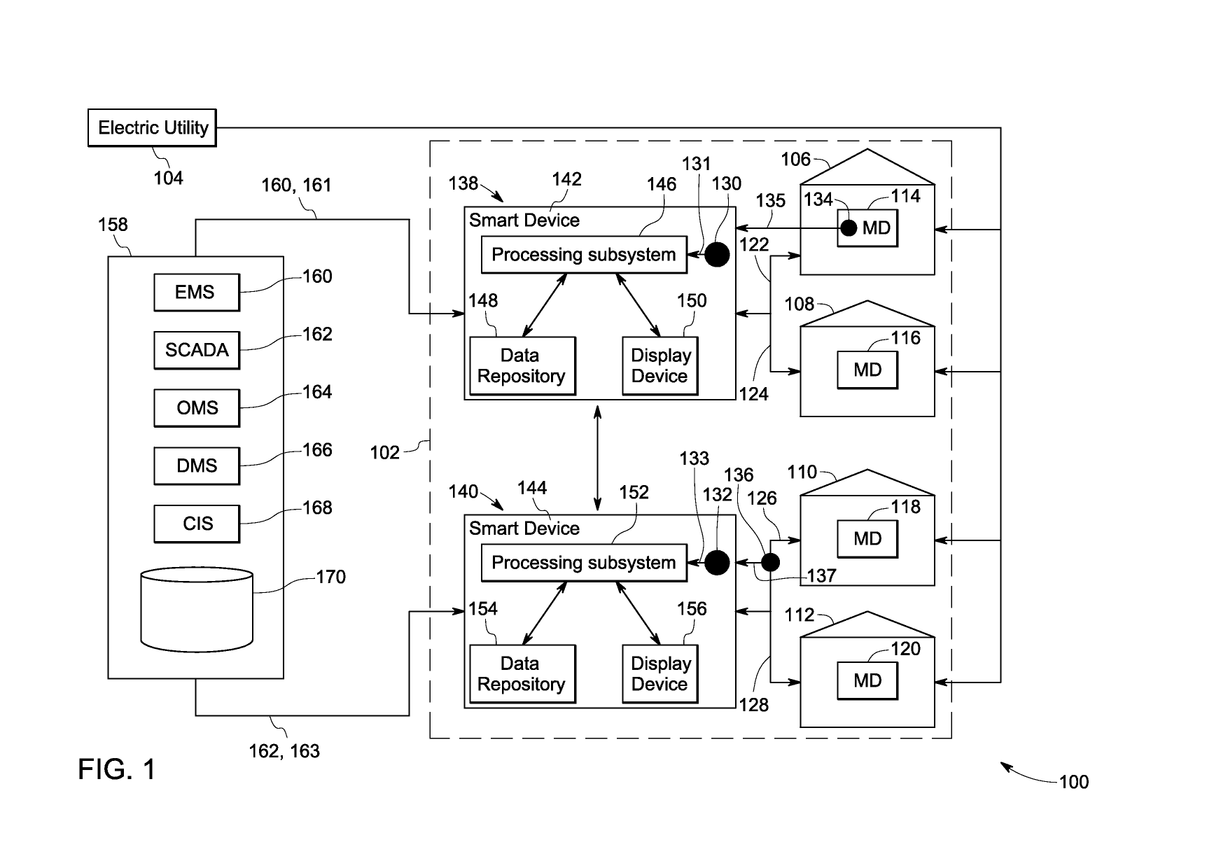

FIG. 1 is a diagrammatic illustration of components in a power grid system 100 that controls generation, transmission and distribution of electricity to a plurality of consumers 106, 108, 110, 112. The power grid 100 includes an electric utility 104 that provides electricity to the plurality of consumers 106, 108, 110, 112 via a power distribution system 102. In the presently contemplated configuration, each of the plurality of consumers 106, 108, 110, 112 has a metering device 114, 116, 118, 120. For example, in this embodiment, the consumer 106 has metering device 114 and the consumer 108 has metering device 116. Similarly, the consumer 110 has metering device 118 and the consumer 112 has metering device 120. In one embodiment, each of the metering devices 114, 116, 118, 120, for example, may be a smart meter, an advanced metering device, or the like. In one example the metering devices 114, 116, 118, 120 generates load side data. As used herein, the term “load side data” may be used to refer to data related to electrical power supplied to or received by one or more consumers from an electric utility. As used herein, consumer refers to residential, industrial, or government consumers.

As shown in FIG. 1, metering device 114 generates load side data 122, while metering device 116 generates load side data 124. Similarly, metering device 118 generates load side data 126 and metering device 120 generates load side data 128. The load side data, for example, may include power usage data, real-time load data, dynamic load data, power outage notification, pre-fault load data and power quality monitoring parameters, or the like. As used herein, the term, “power usage data” may be used to refer to a total amount of consumption of power by a consumer in a determined time period. Also, the term “dynamic load data” may be used to refer to loading information at different parts of the system at different points of time. Furthermore, the term “real-time load data” may be used to refer to an amount of power consumed by a consumer in real-time. Again, the term “pre-fault load” may be used to refer to an amount of power consumed by a consumer in a determined time period prior to an electrical fault at a determined location. As used herein, the term “power quality monitoring parameters” may be used to refer to one or more parameters that may be used to determine the quality of power that is supplied to a consumer or is carried by a feeder. The power quality monitoring parameters, for example, may include total harmonic distortion, voltage sag, noise level, or the like. Similarly, the term “power outage notification” may be used to refer to a notification that implies power outage at a consumer's location.

In the presently contemplated configuration, the power grid system 100 includes a plurality of sensing devices 130, 132, 134, 136. The sensing devices 130, 132, 134, 136 generate signals that are representative of electrical characteristics 131, 133, 135, 137, respectively, at respective locations. As used herein, the term “electrical characteristics” may be used to refer to measurable electrical quantity and quality parameters. The electrical characteristics, for example, may include voltage, power, current, quality factor, or the like. In the presently contemplated configuration, sensing device 130 is located at a load bifurcation point 138 and sensing device 132 is located at a load bifurcation point 140. As used herein, the term “load bifurcation point” may be used to refer to a location in a power distribution network wherein current carried by a feeder is divided into two or more portions. The load bifurcation point, for example may be a location on a feeder, a transformer, or the like. Additionally, the sensing device 134 is located on metering device 114 and sensing device 136 is located on a feeder. It is noted that the count and locations of the sensing devices 130, 132, 134, 136 are shown for exemplary purposes, and should not be restricted to the illustrated embodiments.

The power grid 100 or the power distribution network 102 further includes a plurality of smart devices 142, 144 that are located at load bifurcation points. In this embodiment, smart device 142 is located at the load bifurcation point 138 and smart device 144 is located at load bifurcation point 140. The smart devices 142, 144, for example, may be processing devices or microcontrollers that may be coupled to an input device, an output device and a data repository. As shown in FIG. 1, smart device 142 includes a processing subsystem 146, a data repository 148 and a display device 150. Similarly, smart device 144 includes a processing subsystem 152, a data repository 154 and a display device 156.

The smart devices 142, 144 are operationally coupled to a subset of the metering devices 114, 116, 118, 120 and the sensing devices 130, 132, 134, 136. In one embodiment, each of the smart devices 142, 144 may be operationally coupled to a subset of the metering devices 114, 116, 118, 120 and a subset of the sensing devices 130, 132, 134, 136 based upon the locations of the metering devices 114, 116, 118, 120 and sensing devices 130, 132, 134, 136 with respect to the smart devices 142, 144. For example, a sensing device SD or a metering device MD may be operationally coupled to a smart device SMD that is located in the region/area of a distribution substation of the sensing device SD and/or the metering device MD. By way of another example, a smart device may be operationally coupled to a metering device and a sensing device that is located in the local area network of the smart device. In the presently contemplated configuration, smart device 138 is operationally coupled to metering devices 114, 116 and the sensing devices 130, 134. Additionally, smart device 144 is operationally coupled to the metering devices 118, 120 and the sensing devices 132, 136. In certain embodiments, the smart devices 142, 144 may be operationally coupled to one another.

In the presently contemplated configuration, the smart devices 142, 144 receive the load side data 122, 124, 126, 128 and electrical characteristics 131, 133, 135, 137 from the metering devices 114, 116, 118, 120 and sensing devices 130, 132, 134, 136. Particularly, in the presently contemplated configuration, the smart device 142 receives the load side data 122, 124 and the electrical characteristics 131, 135 from the metering devices 114, 116 and sensing devices 130, 134, respectively. Similarly, as shown in FIG. 1, the smart device 144 receives load side data 126, 128 and the electrical characteristics 133, 137 from metering devices 118, 120 and sensing devices 132, 136, respectively. It is noted that smart devices 142 are located in the local area network or the area of a distribution substation of metering devices 114, 116 and sensing devices 130, 134, the smart device 142 receive the load side data 122, 124 and electrical characteristics 131, 135 in real-time. Furthermore, the bandwidth required for transmission of the load side data 122, 124 and electrical characteristics 131, 135 is reduced.

Each of smart devices 142, 144 further receives supervisory controls and supervisory conditions from a control center 158. Particularly, smart device 142 receives supervisory controls 160 and supervisory conditions 161 from the control center 158. Furthermore, smart device 144 receives supervisory controls 162 and supervisory conditions 163 from the control center 158. As used herein, the term “supervisory controls” may be used to refer to directions on execution of one or more actions/reactions that are sent by a control center to a smart device, and are executed by the smart device based upon satisfaction of one or more supervisory conditions. The supervisory controls 160, 162 and supervisory conditions 161, 163, for example, may be controls and conditions that are generated by a plurality of control applications in the control center 158. The control applications, for example, may be a demand management application, a targeted load management application, a demand side management application, a dynamic or time of use based load curtailment application, an energy auditing application, a differentiated reliability services application, a restoration based on customer prioritization application, a load balancing application, or the like.

It is noted that the supervisory controls 160, 162 and supervisory conditions 161, 163 may be different for different control applications. The control center 158, for example, may send the supervisory controls 160, 162 and supervisory conditions 161, 163 as per requirement at discreet time intervals. For example, when one or more of the control applications in control center 158 determine that certain supervisory controls should be executed in a determined region, control center 158 may send the supervisory controls and supervisory conditions to one or more smart devices located in the determined region. By way of a non-limiting example, when control center 158 decides to manage in real-time, the consumption of power by electric vehicles of consumers 106, 108 based upon real time load of consumers 106, 108, 110, 112, control center 158 may send certain supervisory controls and supervisory conditions to the smart device 142. Certain examples of supervisory controls and supervisory conditions are explained below via Table 1.

TABLE 1

| | | | Directions on |
|---|---|---|---|
| | | | checking for the |
| | | | satisfaction of a |
| Serial | | | supervisory |
| No. | Supervisory Control | Supervisory Condition | condition |
| 1. | Limit demand of | If a transformer | In real-time, |
| | electricity of a | loading = 95% | demand |
| | consumer = 2 KW, | of full load of a | management |
| | and disconnect a | transformer | application |
| | smart meter if demand | | |
| | is greater than 2 KW | | |
| 2. | Switch off low priority | After fault is isolated, | In real-time, |
| | metering devices | load to be restored > | restoration based |
| | | capacity of the | on customer |
| | | restoring feeder | prioritization |
| | | | application |
| 3. | Switch off the | If electric vehicles are | In real-time, a |
| | metering devices | charged at any other | dynamic or time |
| | | time than the decided | of use based load |
| | | time | curtailment |
| | | | application |
| 4. | Switch Phase for some | If Phase imbalance > | On each instance |
| | metering devices | Determined value | of receipt of |
| | | | demand load |
| | | | information, load |
| | | | balancing |
| | | | application |

The smart devices 142, 144 store the received supervisory controls 160, 162 and supervisory conditions 161, 163 in a respective data repository 148, 154. For example, the smart device 142 stores the supervisory controls 160 and the supervisory conditions 161 in the respective data repository 148. Similarly, smart device 144 stores the supervisory controls 162 and supervisory conditions 163 in the respective data repository 154. The smart devices 142, 144 execute the supervisory controls 160, 162 based upon satisfaction of the supervisory conditions 161, 163. The smart devices 142, 144 determine whether the supervisory conditions 161, 163 are satisfied based upon the load side data 122, 124, 126, 128 and/or the electrical characteristics 131, 133, 135, 137. In certain embodiments, smart devices 142, 144 may determine whether the supervisory conditions are satisfied at regular intervals. In certain alternative embodiments, supervisory controls 160, 162 may include directions when the satisfaction of supervisory conditions 161, 163 may be checked. In such alternative embodiments, smart devices 142, 144 may check for the satisfaction of the supervisory conditions 161, 163 based upon the directions.

When smart devices 142, 144 determine that one or more of the supervisory conditions 161, 163 are satisfied or met, smart devices 142, 144 may execute the respective supervisory controls 160, 162. For example, when smart device 142 determines that one or more of the supervisory conditions 161 are satisfied, smart device 142 may execute the supervisory control 160. Similarly, when smart device 144 determines that one or more of the supervisory conditions 163 are satisfied, smart device 144 may execute the supervisory control 162.

The smart devices 142, 144 may execute supervisory controls as long as the supervisory conditions are met. In an example 1, the control center 158 sends a supervisory condition to the smart device 142 to disconnect any metering device in real time which meets the followings conditions with an error bound of 2%:

(1) A metering device exceeds a load consumption of about 2 KW; and

(2) Transformer loading exceeds about 90% of its rated power

In the example 1, when the supervisory conditions (1) and (2) are met by any metering device, the smart device 142 may disconnect the metering device that meets the supervisory conditions (1) and (2). In this example 1, the term “error bound” is used to refer to an indication of a lower limit of transformer loading. Accordingly, that smart device 142 executes the supervisory control when the transformer loading is greater than 88% of its rated power. Smart device 142 continuously receives load data from metering devices 114, 116, 118, 120 and transformer loading information from transformer sensor TS. In the presently contemplated configurations, the control center 158 enables the smart devices 142, 144 to have partial processing and decision making capabilities. Therefore, while smart devices 142, 144 have certain decision making and control capabilities, such decision making and control capabilities are limited to the supervisory controls and supervisory conditions.

In the presently contemplated configuration, control center 158 includes a plurality of control applications 160, 162, 164, 166, 168 that generate supervisory controls 160, 162 and supervisory conditions 161, 163. The plurality of control applications 160, 162, 164, 166, 168 include an Energy Management System (EMS) 160 that performs load forecasting, and monitors, controls, and optimizes the performance of electricity generation and transmission systems. A Supervisory Control And Data Acquisition (SCADA) 162 provides real time information at different points in the electric utility 104 and also provides local controls. An Outage Management System (OMS) 164 monitors load status information and outage restoration information. Some of the functions performed by the OMS 164 may include failure prediction, providing information on the extent of outages and impact to the consumers 106, 108, 110, 112 and prioritizing restoration efforts. Furthermore, a Distribution Management System (DMS) 166 provides real-time response to adverse or unstable network conditions by providing information on load status and load response. A Demand Response Management System (DRMS) 168 is used to initiate demand response events to reduce or curtail load through price or direct control signals from the utility to the consumer devices. Consumer information, such as, consumers' data, contractual obligations data, responses of the consumers 106, 108, 110, 112 to load shed requests, and the like is monitored and controlled by a Consumer Information System (CIS) 168. The control center 158 also includes a data storage unit 170 for storing data, such as, supervisory controls 160, 162 and supervisory conditions 161, 163, historical load data, or the like.

Communication between the consumers 106, 108, 110, 112, control center 158, smart devices 142, 144 and the electric utility 104 can occur via a WAN (e.g., Internet), WiMAX, broadband, AMI, and/or power line carriers, for example. Communication can also occur via a private network. Any suitable means for communication can be used. The control center 158 can be arranged at and/or hosted by the utility 104 and/or by any other party. The smart devices 142, 144 can be hosted by the utility 104 and/or by any other party.

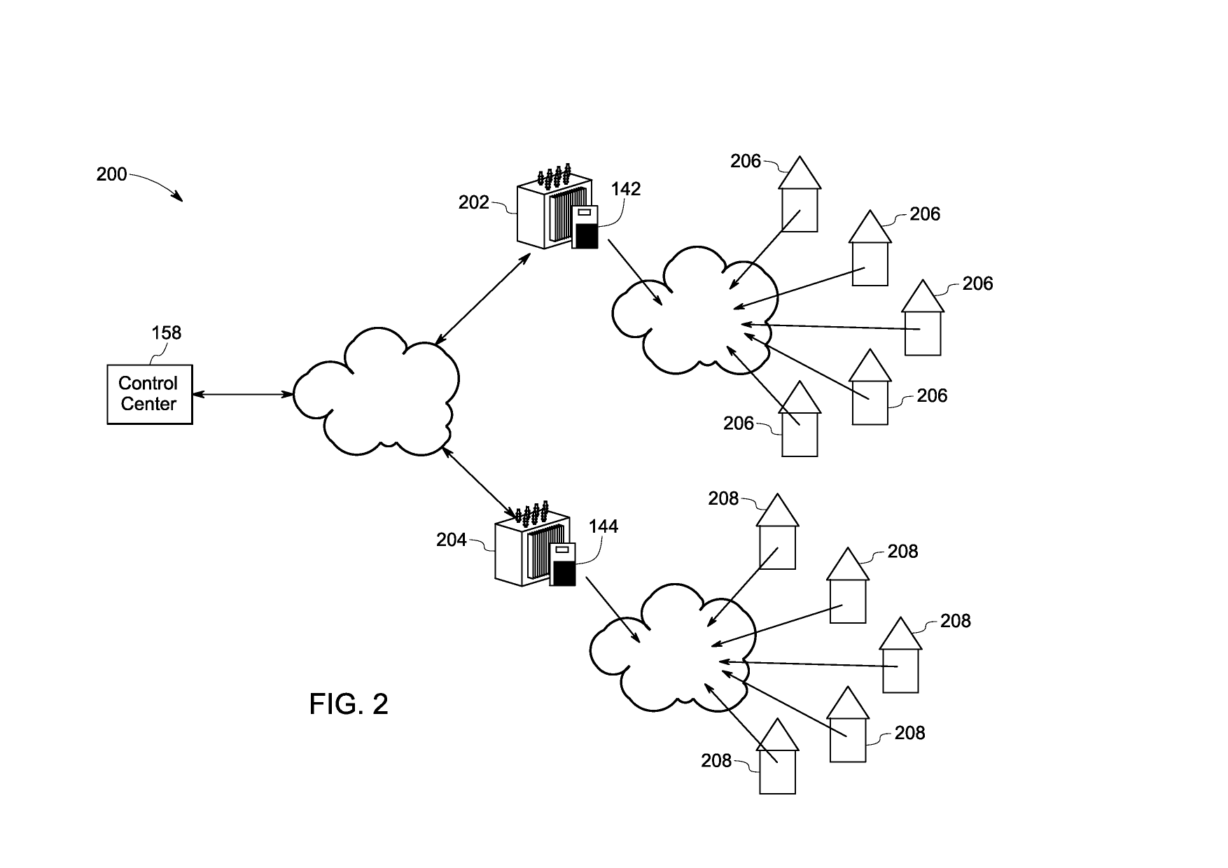

FIG. 2 is a diagrammatic illustration of a power distribution system 200, in accordance with an embodiment of the present systems and techniques. As shown in FIG. 2, the power distribution system 200 includes the control center 158 (see FIG. 1) that is operationally coupled to the plurality of smart devices 142, 144. In the presently contemplated configuration, smart devices 142, 144 are located on transformers 202, 204, respectively. The smart device 142 receives load side data and electrical characteristics from metering devices and sensing devices located in the local area network of a first set of consumers 206. Additionally, smart device 144 receives load side data and electrical characteristics from metering devices and sensing devices located in the local area network of a second set of consumers 208. Furthermore, as previously noted with reference to FIG. 1, smart devices 142, 144 receive supervisory controls and supervisory conditions from the control center 158. For example, smart device 142 executes the received supervisory controls on the first set of consumers 206 based upon satisfaction of the received supervisory conditions. Similarly, smart device 144 executes the received supervisory controls on the second set of consumers 208 based upon satisfaction of received supervisory conditions. It is noted the satisfaction of supervisory conditions may be determined based upon load side data and/or electrical characteristics.

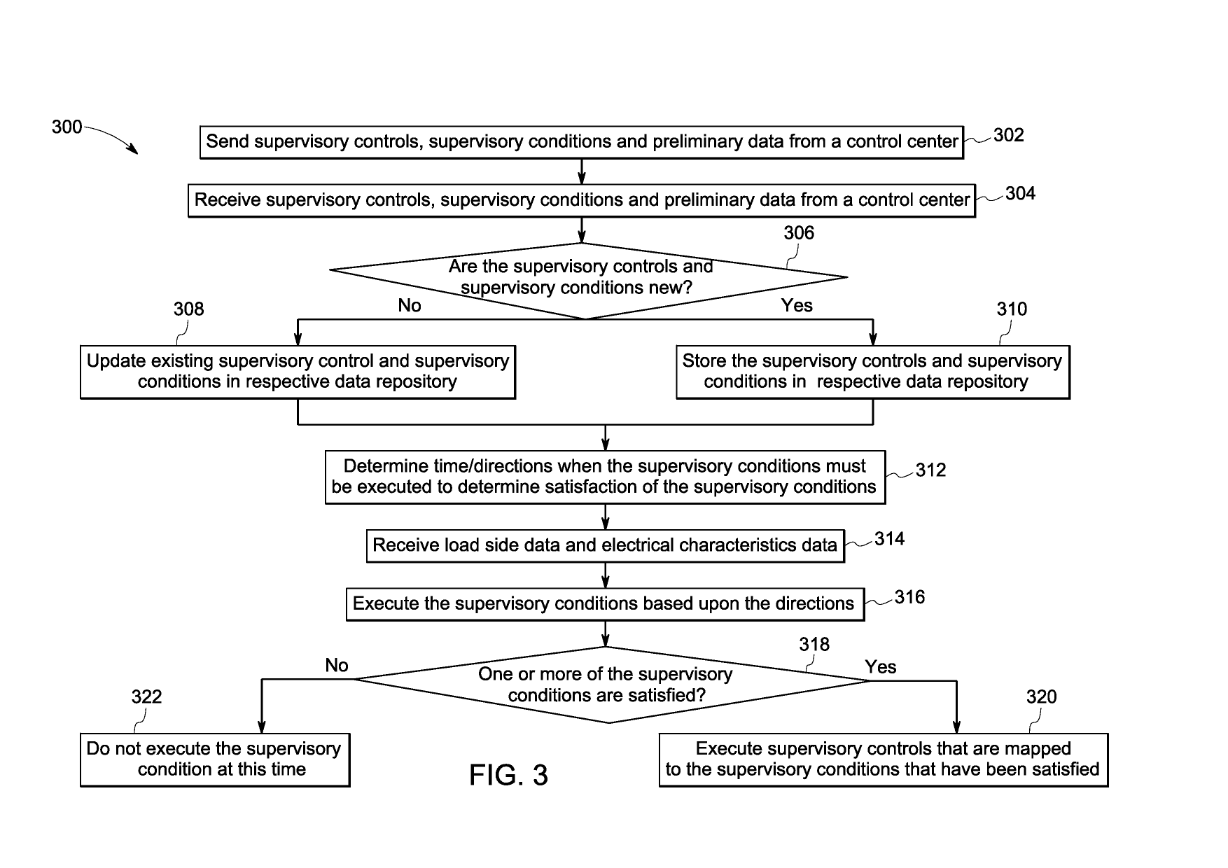

FIG. 3 is an exemplary flow diagram 300 that describes an optimal management and control of a power distribution network, in accordance with an embodiment of the present techniques. At step 302 supervisory controls and supervisory conditions may be sent by control center 158. It is noted that each supervisory condition is mapped to at least one supervisory control. For example, when a supervisory condition is: when a load of a consumer increases beyond a determined value, the supervisory control may be: limit the consumption of electricity of the consumer to a determined value. Furthermore, in certain embodiments, preliminary data may be sent by control center 158. As used herein, the term “preliminary data” may be used to refer to data that may be required by smart devices for execution of the supervisory controls or verifying the satisfaction of the supervisory conditions. The preliminary data, for example, may include an electric vehicle charging schedule, a priority list of consumers, forecasted load, payment defaulters, or the like.

The supervisory controls and supervisory conditions, for example, may be sent to one or more selected smart devices, such as, smart devices 142, 144 (see FIG. 1). It is noted that each of the supervisory controls and supervisory conditions may not be sent to each smart device. For example, with reference to FIG. 1, the supervisory controls and supervisory conditions may be sent to smart device 142, and not to the smart device 144. Similarly, a subset of the supervisory controls and supervisory conditions may be sent to selected smart device 142, and the rest of the supervisory controls and supervisory conditions may be sent to selected smart device 144.

In one embodiment, the supervisory controls and supervisory conditions may be sent by control center 158 based upon a requirement of control center 158 for optimal management of the power grid system 100. At step 304 the supervisory controls, supervisory conditions and the preliminary data may be received by the selected smart devices, such as, smart devices 142, 144. Furthermore, at step 306, the selected smart devices verify whether the received supervisory controls and supervisory conditions are new or relate to earlier received/stored supervisory controls and supervisory conditions. The verification, for example, may be carried out by the selected smart devices that received the supervisory controls and supervisory conditions. For verification, the selected smart devices may compare the received supervisory controls and supervisory conditions with existing/stored supervisory controls and supervisory conditions in respective data repository. When at step 306, it is determined that the received supervisory controls and supervisory conditions are similar to stored supervisory controls and supervisory conditions or are not new, the control is transferred to step 308. In the following example 1, when a smart device has a stored supervisory control and supervisory condition A:
Stored supervisory condition A: When a transformer load>95%, then execute the following supervisory control
Stored supervisory control A that is mapped to the above supervisory condition: Limit each customer electricity demand to 2 KW, (demand management application)

Furthermore, when the smart device receives another supervisory control and supervisory condition B as follows:
Received supervisory condition B: When a transformer load>95% then execute the following supervisory control
Received supervisory control that is mapped to the above supervisory condition B: Limit each customer electricity demand to 4 KW

In the abovementioned example, when the selected smart device compares the stored/existing supervisory controls and supervisory conditions A to the received supervisory controls and supervisory conditions B, the smart device may determine that A is similar to B except the limit (4 KW) of electricity demand. In this example, at step 306, the smart device may determine that A is similar to B, and transfer the control to step 308. At step 308, the smart device may update the existing supervisory controls and supervisory conditions using dissimilar data in the received supervisory control and supervisory condition. Therefore, in abovementioned example 1, the smart device may update the demand limit of 4 KW in the existing supervisory controls and supervisory conditions A.

With returning reference to step 306, when it is determined that the received supervisory controls and supervisory conditions are new, the control is transferred to step 310. In certain embodiments, each supervisory control and supervisory condition that is new may have a unique number, and when the smart device determines that the received supervisory controls and supervisory conditions have a unique number, the smart device may determine that the received supervisory controls and supervisory conditions are new. At step 310, the received supervisory controls and supervisory conditions are stored in a data repository. For example, when the smart device 142 receives new supervisory controls and supervisory conditions, the smart device 142 may store the new supervisory controls and supervisory conditions in the respective data repository 148.

Subsequently at step 312, the smart device may determine time periods for execution of the received supervisory conditions. In one embodiment, the smart device may determine the time periods based upon the received supervisory controls. In such embodiment, the supervisory controls may include directions on the time periods for execution of the supervisory conditions. For example, a supervisory control may include a direction to execute a direction after every two minutes, or on receipt of specified load side data or electrical characteristics. In alternative embodiments, the smart device may determine a time of execution of the received supervisory conditions based upon a type of a control application that generated the supervisory controls and supervisory conditions. For example, when the supervisory conditions are generated by or relate to a transformer overload mitigation application which requires real time execution of the supervisory controls and supervisory conditions, then supervisory controls and supervisory conditions may be executed in real-time.

At step 314, each of the selected smart devices may receive load side data from a plurality of respective metering devices, such as, the metering devices 114, 116, 118, 120. Furthermore, at step 316, each of the selected smart devices may receive electrical characteristics from a plurality of sensing devices, such as, the sensing devices 130, 132, 134, 136. It is noted that the selected smart device may receive the load side data and the electrical characteristics in real-time. Furthermore, at step 316, the selected smart devices may execute the received supervisory conditions at time periods that have been determined at step 312. Subsequently at step 318, the selected smart devices may verify whether the supervisory conditions have been satisfied. At step 318, when the selected smart device determines that the supervisory conditions have been satisfied or met, the control is transferred to step 320.

The supervisory conditions, for example, may include range or numerical values of one or more of the load side data or the electrical characteristics data. The supervisory conditions, for example, may be satisfied when one or more values of the load side data and the electrical characteristics at a determined location is equal to, less than or greater than a numerical value as defined in the supervisory conditions. For example, a supervisory condition SC1 may include a time range R1 when electrical vehicles of a consumer C should not be charged. In this example, when the consumer C charges his vehicle in the time range R1 as specified in the supervisory condition SC1, the supervisory condition SC1 is satisfied. Similarly, in another example, a supervisory condition SC2 may indicate that a consumer should be disconnected if he consumes power more than 4 kW. In this example, when the load of a consumer exceeds 4 kW, the supervisory condition SC2 is satisfied. In certain other embodiments, a supervisory condition may include error bounds for determination of satisfaction of the supervisory conditions. For example, a supervisory condition SC3 may include a condition that unpaid bill amount of a consumer may not exceed. USD 190. In the example, when the unpaid bill amount of a consumer exceeds USD 190, the supervisory condition is satisfied or met.

At step 320, the received supervisory controls that are mapped to the satisfied supervisory condition are executed. In example 1, when the supervisory condition A is satisfied, the supervisory control: “limit electricity demand to 2 KW” may be executed. However, at step 318, when it is determined that the received supervisory conditions are not satisfied, the control may be transferred to step 322. At step 322, the supervisory condition is not executed.

The present systems and techniques help in better control of smart meters and execution of load side applications in distribution systems. The presence of the smart devices at the load bifurcation points and within the vicinity or local area grid of smart meters leads to real-time monitoring and control of smart meters. The bottle necks that arise due to delay in communications and implementation of active control by a centralized control center are overcome with the implementation of the present techniques and systems.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A power distribution network system, comprising:
a plurality of metering devices configured to generate load side data;
a plurality of processing subsystems that is in operational communication with at least one of the plurality of metering devices and a central processing subsystem, wherein the plurality of processing subsystems is configured to:
receive a subset of the load side data from at least one of the plurality of metering devices;
receive supervisory controls and supervisory conditions from the central processing subsystem;
determine whether one or more of the supervisory conditions are satisfied based upon the received subset of the load side data; and
execute one or more of the supervisory controls based upon the determination whether one or more of the supervisory conditions are satisfied,
wherein each of the plurality of processing subsystems is located at a load bifurcation point in the power distribution network.

2. The power distribution network system of claim 1, further comprising a plurality of sensing devices that are in operational communication with at least one of the plurality of processing subsystems, wherein the sensing devices generate signals that are representative of electrical characteristics of respective locations.

3. The power distribution network system of claim 2, wherein the plurality of processing subsystems are further configured to:
receive a subset of the electrical characteristics from at least one of the plurality of sensing devices;
determine whether one or more of the supervisory conditions are satisfied based upon the received subset of the load side data and the subset of the electrical characteristics; and
execute one or more of the supervisory controls that are mapped to one or more of the supervisory conditions based upon the determination whether one or more of the supervisory conditions are satisfied.

4. The power distribution network system of claim 2, further comprising:
receive preliminary data corresponding to at least one of a plurality of electric utility applications from the central processing subsystem; and
determine whether one or more of the supervisory conditions are satisfied based upon the received subset of the load side data, the subset of the electrical characteristics data, preliminary data, or combinations thereof; and
execute one or more of the supervisory controls that are mapped to one or more of the supervisory conditions based upon the determination whether one or more of the supervisory conditions are satisfied,

5. The power distribution network system of claim 1, wherein determining whether one or more of the supervisory conditions are satisfied comprises determining whether one or more values of the load side data and the electrical characteristics at a determined location is equal to, less than or greater than a numerical value as defined in the supervisory conditions.

6. The power distribution network system of claim 1, wherein the supervisory controls are mapped to one or more of the supervisory conditions.

7. The power distribution network system of claim 5, wherein the plurality of processing subsystems are configured to execute one or more of the supervisory controls based upon the mapping of the supervisory controls to the supervisory conditions.

8. The power distribution network system of claim 1, wherein the plurality of metering devices comprise smart meters, advanced metering devices, or combinations thereof.

9. The power distribution network system of claim 1, wherein the load side data comprises power usage data, dynamic load data, power outage notification, pre-fault load data, real-time load data, pre-fault load data and power quality monitoring parameters of respective location.

10. The power distribution network system of claim 1, wherein the plurality of sensing devices are located on feeders, smart meters, the bifurcation point, or combinations thereof.

11. The power distribution network system of claim 1, wherein the electrical characteristics comprises: voltage, power, current, quality factor, or combinations thereof.

12. The power distribution network system of claim 1, wherein the load bifurcation point comprises a location on a feeder, a transformer.

13. The power distribution network system of claim 1, further comprising a data repository that is operationally coupled to the plurality of processing subsystems, and stores the supervisory controls and the supervisory conditions received from the central processing subsystem at multiple intervals.

14. A power distribution network system, comprising:
a plurality of metering devices configured to generate load side data;
a plurality of smart devices that are in operational communication with at least one of the plurality of metering devices and a central processing subsystem, wherein the plurality of processing subsystems are configured to:
receive a subset of the load side data from at least one of the plurality of metering devices;
receive supervisory controls and supervisory conditions from the central processing subsystem;
determine whether one or more of the supervisory conditions are satisfied based upon the received subset of the load side data; and
execute one or more of the supervisory controls based upon the determination whether one or more of the supervisory conditions are met,
wherein each of the plurality of smart devices is located on a transformer.

15. A method, comprising:
receiving a subset of load side data from at least one metering device;
receiving supervisory controls and supervisory conditions from a central processing subsystem;
determining whether one or more of the supervisory conditions are satisfied based upon the received subset of the load side data; and
executing one or more of the supervisory controls based upon the determination whether one or more of the supervisory conditions are met,
wherein each of the plurality of processing subsystems is located at a load bifurcation point in the power distribution network.
